(19) United States
(12) Patent Application Publication
(10) Pub. No.: US 2025/0331960 A1
(43) Pub. Date: Oct. 30, 2025

(54) ORTHODONTIC DEVICE AND PROCESS OF MANUFACTURING ORTHODONTIC DEVICE

(71) Applicant: Ornge Orthodontics Inc., Hicksville, NY (US)

(72) Inventors: Ammar Ahmed SYED, Unionville (CA); Colin J. COREY, Carlsbad, CA (US); Edward L. MASSARO, Bryn Mawr, PA (US)

(73) Assignee: Ornge Orthodontics Inc., Hicksville, NY (US)

(21) Appl. No.: 19/185,010

(22) Filed: Apr. 21, 2025

Related U.S. Application Data
(60) Provisional application No. 63/639,194, filed on Apr. 26, 2024.

(51) Int. Cl. A61C 7/14; A61C 7/00; A61C 7/08; A61C 7/16; B33Y 50/00; B33Y 80/00

(52) U.S. Cl. CPC A61C 7/146; A61C 7/002; A61C 7/08; A61C 7/16; B33Y 50/00; B33Y 80/00

(57) ABSTRACT

An orthodontic device includes an alignment body, a support member, and a positioning mechanism connecting the support member to the alignment body. The support member includes a bracket receiving structure and is actuatable between a bonding position and a non-bonding position. A process of manufacturing an orthodontic device includes constructing an orthodontic device from data including a three-dimensional model obtained from a patient's dentition, an orthodontic prescription, and a structure of an orthodontic bracket including a bonding surface.

### RELATED APPLICATION

This application claims benefit of priority of U.S. Provisional Application No. 63/639,194, filed Apr. 26, 2024, the entire contents of which are incorporated herein by reference

### FIELD

The present application relates generally to orthodontics, and more specifically relates to devices and methods associated with orthodontics.

### BACKGROUND

Orthodontic bracket placement is generally based on a patient's dentition and an orthodontic prescription for the dentition. A user can directly place orthodontic brackets on a patient's teeth by hand. Direct bracket placement relies on the user's knowledge and skill for accurate placement. Alternatively, a user can apply brackets to teeth by using an indirect bonding apparatus that holds and positions brackets for bonding to the teeth. The apparatus can decrease the time required for a user to place brackets on teeth relative to a direct bracket placement method. An indirect bonding apparatus can also decrease human error in bracket placement relative to direct bracket placement.

The orthodontic industry has utilized additive manufacturing to produce indirect bonding apparatuses having a variety of structures. In some instances, an additive manufacturing process integrally forms orthodontic brackets with an indirect bonding apparatus. Alternatively, an additive manufacturing process can produce an indirect bonding apparatus and a user can later install brackets in the apparatus. In either configuration, users may find existing structures of indirect bonding apparatuses to be cumbersome for applying brackets to a patient's dentition.

### BRIEF DESCRIPTION OF THE DRAWINGS

FIG. 1 illustrates a side view of an embodiment of a positioning mechanism in a state of actuation corresponding to a bonding position;

FIG. 2 illustrates a perspective view of the positioning mechanism shown in FIG. 1;

FIG. 3 illustrates a side view of a cross-section of the positioning mechanism shown in FIG. 1;

FIG. 4 illustrates a perspective view of a cross-section of the positioning mechanism shown shown in FIG. 3;

FIG. 5 illustrates a side view of the positioning mechanism shown in FIG. 1 in a state of actuation corresponding to a position between a bonding position and a non-non-bonding position;

FIG. 6 illustrates a perspective view of the positioning mechanism shown in FIG. 5;

FIG. 7 illustrates a side view of a cross-section of the positioning mechanism shown in FIG. 5;

FIG. 8 illustrates a perspective view of a cross-section of the positioning mechanism shown in FIG. 7;

FIG. 9 illustrates a side view of the positioning mechanism shown in FIG. 1 in a state of actuation corresponding to a non-bonding position;

FIG. 10 illustrates a perspective view of the positioning mechanism shown in FIG. 9;

FIG. 11 illustrates a side view of a cross-section of the positioning mechanism shown in FIG. 9;

FIG. 12 illustrates a perspective view of a cross-section of the positioning mechanism shown in FIG. 11;

FIG. 13 illustrates a plan view of an embodiment of an orthodontic device in a non-bonding position;

FIG. 14 illustrates a perspective view of the orthodontic device shown in FIG. 13;

FIG. 15 illustrates a plan view of the orthodontic device shown in FIG. 13 in a state of actuation corresponding to a bonding position;

FIG. 16 illustrates a perspective view of the orthodontic device shown in FIG. 15;

FIG. 17 illustrates a perspective view of an embodiment of an alignment body connected to embodiments of first members of positioning mechanisms;

FIG. 18 illustrates a front view of the alignment body and first members shown in FIG. 17;

FIG. 19 illustrates a plan view of the alignment body and first members shown in FIG. 17;

FIG. 20 illustrates a side view of an embodiment of a support member connected to an embodiment of a second member of a positioning mechanism;

FIG. 21 illustrates a perspective view of the support member and the second member shown in FIG. 20;

FIG. 22 illustrates a front view of the support member and the second member shown in FIG. 20;

FIG. 23 illustrates a bottom view of the support member and the second member shown in FIG. 20;

FIG. 24 illustrates an embodiment of a bracket receiving including a cavity structured to detachably retain an orthodontic bracket;

FIG. 25 illustrates a plan view of a portion of an embodiment of an orthodontic device in a non-bonding position and including orthodontic brackets detachably retained in bracket receiving structures;

FIG. 26 illustrates a rear perspective view of the orthodontic device shown in FIG. 25;

FIG. 27 illustrates a plan view of the orthodontic device shown in FIG. 25 in a bonding position;

FIG. 28 illustrates a rear perspective view of the orthodontic device shown in FIG. 27;

FIG. 29 illustrates an enlarged perspective view of orthodontic brackets detachably retained in cavities of the bracket receiving structures shown in FIG. 28;

FIG. 30 illustrates an embodiment of a package containing an orthodontic device;

FIG. 31 illustrates a front perspective view of an embodiment of an orthodontic bracket; and

FIG. 32 illustrates an embodiment of a process of manufacturing an orthodontic device.

### DETAILED DESCRIPTION

An orthodontic device can include an alignment body, one or more support members, and one or more positioning mechanisms connecting the one or more support members to the alignment body. In some embodiments, an alignment body defines one or more recesses structured to engage portions of a plurality of a patient's teeth. In some embodiments, recesses of an alignment body are structured to receive and engage portions of a full arch, such as a mandibular or maxillary arch, of the patient's teeth. In some forms, an alignment body can be a tray including a body that defines one or more recesses structured to receive surfaces of a plurality of a patient's teeth. A recess can be structured to receive a portion of one or more teeth in a patient's dentition. In some forms, a recess can receive at least an occlusal surface of a tooth of a patient's dentition and optionally at least one of at least part of a lingual surface or at least part of a facial surface of the tooth. In some embodiments, one or more recesses are structured to receive at least occlusal surfaces of a patient's teeth. An alignment body can be made by any useful process such as additive manufacturing, molding, or machining such as CNC machining.

A recess of an alignment body can comprise a receiving contour structured to receive a portion of a tooth depicted in a three-dimensional model of a patient's dentition. In some embodiments, an alignment body is made by an additive manufacturing process and recesses include receiving contours structured to receive surfaces of a patient's teeth depicted in a three-dimensional model of the patient's dentition. A receiving contour can be calculated from a surface contour of a tooth depicted in a three-dimensional model of a patient's dentition. In some forms, a structure of a receiving contour can be calculated as any of a negative impression, a Boolean subtract, or a mathematical best-fit approximation of a surface contour of a patient's tooth depicted in a three-dimensional model.

A three-dimensional model of a patient's dentition can include surface topography information or surface contours of one or more of a patient's teeth or a patient's complete set of teeth. An electronic file can comprise a three-dimensional model of a patient's dentition that has been captured either directly from a patient's dentition or indirectly from an impression model of a patient's dentition. Examples of useful devices for measuring topography information from a patient's dentition include intraoral scan, cone beam computed tomography taken directly from a patient's dentition or indirectly from an impression model, and a laser scan of an impression model. The measured topography information can be processed by a computing device. The topography information can be generally saved in any useful format such as point cloud data, or any useful file utilized in computer-aided drafting (CAD). The information can be saved using any useful type of memory such as RAM, a solid-state drive, a hard disk, a network drive, or a cloud-based server. A computing device can be programmed to generate a three-dimensional model of a patient's dentition based on the topography information. Examples of a computing device useful in processes and methods provided herein include one or more of a personal computer, a network of computers such as computers connected to one or more of a local area network, a wireless network, a cellular network, and a cloud network.

In some embodiments, an orthodontic device includes a plurality of support members. A support member can include one or more bracket receiving structures. In some embodiments, an orthodontic device includes a bracket receiving structure including a cavity structured to detachably retain an orthodontic bracket. In some embodiments, an orthodontic device includes a bracket receiving structure including an orthodontic bracket detachably retained in a cavity of the bracket receiving structure. An orthodontic bracket can include a bonding surface for bonding to a tooth of a patient's teeth engaged with an alignment body. A cavity of a bracket receiving structure can include a structure that is capable of detachably retaining an orthodontic bracket including a bonding surface such that the bonding surface faces away from the cavity. A support member including one or more bracket receiving structures can be made by any useful process such as additive manufacturing, molding, or machining such as CNC machining.

In some embodiments, an orthodontic device includes a positioning mechanism connecting one or more support members to an alignment body. In some embodiments, an orthodontic device includes a plurality of positioning mechanisms connecting a plurality of support members to an alignment body. In some embodiments, a positioning mechanism is structured to allow reversible movement of a support member including a bracket receiving structure from a non-bonding position to a bonding position and back to the non-bonding position. In some embodiments, a bonding position disposes a bracket receiving structure of a support member in a location that would place a bonding surface of a bracket retained in the bracket receiving structure in a position for bonding to a surface to a tooth engaged with an alignment body. In some forms, a non-bonding position disposes a bracket receiving structure away from an alignment body and away from where a tooth would be located if engaged with the alignment body. In some forms, an orthodontic device includes a plurality of support members and a plurality of positioning mechanisms, and the positioning mechanism can be independently actuated.

A positioning mechanism can have any useful configuration. In some embodiments, a positioning mechanism includes a first member and a second member, and the first member is movably engaged with the second member, the first member is fixed to an alignment body and the second member is fixed to one or more support members to allow movement of the one or more support members between a non-bonding position and a bonding position. In some embodiments, a second member is reversibly movable relative to a first member to permit reversible movement of a bracket receiving structure between bonding and non-bonding positions. In some embodiments, an orthondontic device includes a positioning mechanism that is actuatable to move a bracket receiving structure from a non-bonding position to a bonding position, and the bracket receiving structure can be removed from the bonding position of a tooth by removing the orthodontinc device from a patient's dentition.

In some forms, one of a first member or a second member of a positioning mechanism can include an interior space structured to receive at least a portion of the other of the first or second member such that the first and second members are slideably engaged and can be actuated between states corresponding to a non-bonding position and a non-bonding position. In some embodiments, one of a first member or a second member includes an interior space including a tube structure having a circular cross-section configured to receive at least a portion of the other of the first or second member having relatively smaller circular cross-section such that the first and second members can be moved between states bonding and non-bonding positions, and rotated relative to one another about a common axis.

In some embodiments, a positioning mechanism includes one of a first member or a second member having an interior space including a structured cross-section configured to receive at least a portion of the other of the first or second member having an exterior surface structured to mate with the structured cross-section. In some embodiments, the structured cross-section permits the first and second members to longitudinally actuated between bonding and non-bonding positions, without being rotatable about a common axis. In some forms, one of a first and second member can have an interior space having a structured cross-section and the other of the first and second members can have an identically shaped but smaller-dimensioned cross-section configured to fit within the interior space. A structured cross-section can have any useful configuration. Examples of structured cross-sections include an ovoid cross-section, an elliptical cross-section, a tear-drop-shaped cross-section, a polygon cross-section such as triangular, square, rectangular, hexagonal, or a polygon having any number of faces such as 3, 4, 5, 6, 7, 8, 9, 10, 11, or more, a diamond-shaped cross-section, a crescent-shaped cross-section such as a crescent moon shaped cross-section, a heart-shaped cross-section, a plus-sign, cross, or cross-hair-shaped cross-section, a wavy cross-section, an hourglass-shaped cross-section, a bowtie-shaped cross-section, a star-shaped cross-section such as a Star of David-shaped cross-section, a cloverleaf-shaped cross-section, a toothed gear-shaped cross-section, a serpentine-shaped cross-section, a D-shaped cross-section, a T-shaped cross-section, an S-shaped cross-section, or a cross-section having a profile of an arrow. It is thought that a structured cross-section, such as a cross-shaped cross-section, can provide stability and permit linear motion without rotation.

In some embodiments, a positioning mechanism includes a first member and a second member wherein one of the first or second members includes a track having a yin-shaped cross-section and the other of the first and second members includes a bar having a yang-shaped cross-section mating with the yin-shaped track to permit sliding engagement between the first and second members and movement between bonding and non-bonding positions. In some forms, a collar maintains engagement between the first and second members.

In some embodiments, a positioning mechanism includes a piston including a first member connected to an alignment body and a second member connected to one or more support members, with the first member being movably engaged with the second member. In some forms, a piston would have in internal threaded track or other mechanism that when rotated would index the positioning mechanism from a non-bonding position to a bonding position and be reversible by twisting the piston in the opposite direction and moving to a non-bonding position.

In some embodiments, one of a first or second member of a positioning mechanism includes a tail of a dovetail engagement and the other of the first or second member includes a notch structured to slideably receive the tail and permit relative movement between the first and second members between a non-bonding position and a non-bonding position.

In some forms, a positioning mechanism includes a first member connected to a second member via a hinge to permit the actuation of one or more bracket receiving structures connected to the positioning mechanism to and away from a bonding position.

In some embodiments, a positioning mechanism includes a resilient member that biases a a support member including a bracket receiving structure toward a non-bonding position. Examples of a resilient member include one or more of a spring, an elastomeric member, or any other flexible or elastically deformable structure or material. In some embodiments, a positioning mechanism includes a first member connected to an alignment body, a second member connected to a support member, the first member includes an interior space receiving a portion of the second member, and a resilient member is disposed between the first member and the second member within the interior space. In some forms, a resilient member of a positioning member can bias a support member of an orthodontic device to a non-bonding position after an orthodontic bracket retained in a cavity of a bracket receiving structure of the support member is bonded to a tooth, such that the resilient member retracts the bracket receiving structure away from the tooth while leaving the bracket bonded to the tooth. In some embodiments, a first member can include a magnet and a second member can include an oppositely poled magnet, and the magnets can bias the positioning member toward a non-bonding position similar to the action provided by a resilient member.

A positioning mechanism can include a lock mechanism. A lock mechanism can have any useful configuration. In some forms, a lock mechanism can be structured to lock a positioning mechanism in either one or both of a bonding position and a non-bonding position.

In some embodiments, a positioning mechanism includes a rotating cam mechanism to permit movement between bonding and non-bonding positions. In some embodiments, a rotating cam mechanism can be provided in a positioning member including a first member connected to an alignment body, a second member connected to a support member, with the first member including an interior space receiving a portion of the second member, and a resilient member disposed between the first member and the second member within the interior space. As the second member is pushed forward the resilient member is compressed, a cam interacts with a structure of the second member and rotates and locks into a first orientation locking the positioning member in a bonding position. With a subsequent actuation of the second member, the cam would rotate to a second orientation, unlocking from the second member and allowing the resilient member to push the second member back to a non-bonding position.

In some embodiments, a positioning mechanism includes a triangle cam mechanism, such as a ‘rocker’ cam such as in a click pen, that permits movement between bonding and non-bonding positions. In some embodiments, a triangle cam mechanism can be provided in a positioning member including a first member connected to an alignment body, a second member connected to a support member, with the first member including an interior space receiving a portion of the second member, and a resilient member disposed between the first member and the second member within the interior space. In some embodiments, upon actuating the second member toward a bonding position, the triangle or ‘rocker’ cam would clear an obstacle and move into a locked position when the second member is actuated to the bonding position. With a subsequent actuation of the second member, the cam would unlock and the resilient member would push the second member back toward the non-bonding position.

In some embodiments, a positioning mechanism includes one or more magnets and a structure permitting magnetic retention of the positioning mechanism in a bonding position, a non-bonding position, or one or more intermediate positions between the bonding and non-bonding positions. In some embodiments, a positioning mechanism includes a first member and a second member, the first member includes a magnet and the second member includes an oppositely poled magnet such that movement of the two members into a configuration corresponding to a bonding position brings the two magnets into attractive contact at the bonding position. In some embodiments, a positioning mechanism includes a magnetic detent mechanism permitting movement between bonding and non-bonding positions. In some embodiments, one of a first or second member includes a spring-loaded magnetic detent that engages with ferrous material or magnetic features of the other of the first and second members and provides a click-and-hold functionality until sufficient force is applied to overcome the magnetic attraction and permit movement to another position. In some embodiments, a positioning mechanism includes a magnetic repulsion mechanism permitting movement of the positioning mechanism between bonding and non-bonding positions.

In some embodiments, a positioning mechanism includes a ratchet engagement mechanism permitting movement of the positioning mechanism between bonding and non-bonding positions. In some embodiments, a ratchet engagement, such as a zip tie engagement, exists between and first and second members of a positioning mechanism such that one of the members includes a protruding portion and the other member includes a ratchet track with which the protruding portion engages, and the two members are retained together with a structure such as a collar such that the protruding portion engages the track. In some forms, a ratchet mechanism includes a spring plunger or cantilever beam that indexes with a series of ridges provided on another member to permit movement of the positioning mechanism from a non-bonding position to a bonding position. After passing a ridge, the rachet mechanism can lock into place allowing for travel only toward a bonding position. In some forms, the ratchet mechanism can include a mechanical release that retracts the plunger or cantilever and permits movement of the positioning mechanism toward the non-bonding position.

In some embodiments, a positioning mechanism includes a rotating ratchet engagement permitting movement of the positioning mechanism between bonding and non-bonding positions. In some embodiments, a rotating ratchet engagement includes a first member including a track of ridges a second rotating member including a protrusion for engagement of the ridges. The rotating member can be spring-loaded and spring-loaded rotating engagement of the protrusion with ridges of the track. Upon actuating the positioning member toward a bonding position, the protrusion of the rotating member engages the ridges and prevents movement of the positioning mechanism toward a non-bonding position. In some forms, a rotating ratchet engagement can include a mechanical release to disengage the rotating member and permit movement of the positioning member toward a non-bonding position.

In some embodiments, a positioning mechanism includes a screw engagement permiting movement between bonding and non-bonding positions. In some embodiments, a positioning mechanism includes a screw mechanism, such as a lead screw and a collar attached to one or more support members including bracket receciving structures. Rotation of the screw in one direction drives the collar and support member towared a bonding position and rotation of the screw in the opposite direction drives the collar and support member toward a non-bonding position.

In some embodiments, a positioning mechanism includes a rack and pinion engagement that permits movement between bonding and non-bonding positions. In some embodiments, a positioning member includes a rack connected to an alignment body and a pinion engaged with the rack and connected to one or more support members including bracket receciving structures. Rotation of the pinion in a first direction moves the support member toward a bonding position and rotation of the pinion in a second direction moves the support member toward a non-bonding position.

In some embodiments, an orthodontic device includes one or more positioning mechanisms including a worm screw mechanism structured to move a support member including one or more bracket receiving structures between bonding and non-bonding positions. In some embodiments, a positioning mechanism includes a housed plunger including teeth in engagement with a worm screw. The worm screw can be rotated in a fixed location relative to an alignment body or a support member to advance or retract the plunger to or from a bonding position.

In some embodiments, a positioning mechanism includes a telescoping pole engagement that permits movement between bonding and non-bonding positions. In some embodiments, a positioning mechanism includes a first member and a second member telescopically engaged with interior space in the first member, and a bushing within the cavity. The bushing is expandable upon rotation of the first member relative to the second member about the same axis in a first direction and contractable upon rotation in a second direction. The pole engagement can be loosened twisting the two members in the second direction to contract the bushing and permit shortening of the positioning mechanism to a bonding position by moving the second member further inside the intrior space of the first member, or lengthening of the positioning member to a non-bonding position by drawing the second member from the interior space. The positioning member can be prevented from extending or shortening by twisting the first and second members in the first direction and expanding the bushing.

In some embodiments, a positioning mechanism includes a first member and a second member and ball bearings disposed between the first and second members to aid the movement of the members between bonding and non-bonding positions.

In some embodiments, a positioning mechanism includes a spring-loaded ball plunger mechanism or a spring-loaded detent mechanism permitting movement of the positioning mechanism between bonding and non-bonding positions. In some embodiments, a spring-loaded ball or pin engages with a series of detents or recesses that allow the positioning mechanism to move and engage from one position to another and require overcoming a spring force to move between positions.

In some embodiments, a positioning mechanism includes a toggle mechanism permitting movement of the positioning mechanism between bonding and non-bonding positions. In some embodiments, a toggle latch mechanism can be toggled between positions and provides a clicking engagement when a latch of the latch mechanism engages with a corresponding lock feature. Releasing the toggle latch mechanism allows the positioning mechanism to move to another position.

In some embodiments, a positioning mechanism includes a ball and groove mechanism permitting movement of the positioning mechanism between bonding and non-bonding positions. In some embodiments, one of a first or second member includes a ball bearing or rolling element that moves within a grooved track formed in the other of the first or second member. The grooves of the track can provide discrete clicks as the ball moves along the track. The grooves can act as detents, holding the positioning mechanism in a position until force is applied to move to another position and engage with another groove of the track.

In some embodiments, a positioning mechanism includes a friction clutch mechanism permitting movement of the positioning mechanism between bonding and non-bonding positions. In some embodiments, a friction clutch mechanism engages with specific positions during movement between bonding and non-bonding positions, providing resistance to movement until sufficient force is applied to overcome the friction and move to another position. In some forms, friction level can be adjusted to a control-click-feel and holding force at each position of the positioning mechanism.

In some embodiments, a positioning mechanism includes a solenoid-driven locking mechanism permitting movement between bonding and non-bonding positions. In some embodiments, one of the first or second member includes a solenoid structured to drive a locking pin or bolt into engagement with one or more locking features on the other of the first or second member to provide a click when engaged to hold the positioning mechanism in position until the solenoid is actuated to release the lock and allow movement of the positioning mechanism to another position.

In some embodiments, a positioning mechanism includes an indexing paul and ratchet mechanism permitting movement between bonding and non-bonding positions. In some embodiments, one of a first or second member includes an indexing pawl that engages with a ridged ratchet on the other of the first or second member, providing discrete clicks as the pawl moves over the ridges. The pawl can lock into place at each ridge, holding the positioning mechanism in position until moving the pawl to another ridge.

In some embodiments, a positioning mechanism includes an leaf spring mechanism permitting movement between bonding and non-bonding positions. In some forms, a leaf spring mechanism includes a leaf spring that flexes as the positioning mechanism moves from one position to another, providing tactile feedback and a clicking sensation as it passes over discrete points. In some forms, the leaf spring engages with corresponding features of the positioning mechanism to hold it in place at different positions.

In some forms, one or more parts of a positioning mechanism can be made by any useful process such as additive manufacturing, molding, or machining such as CNC machining. In some embodiments, a first member of a positioning mechanism can be integrally formed with an alignment body. In some embodiments, a second member of a positioning mechanism is integrally formed with one or more support members. In some forms, a positioning mechanism can be assembled by engaging a first member with a second member. In some embodiments, a first member of a positioning mechanism can be integrally formed with an alignment body of an orthodontic device using an additive manufacturing process, a second member of the positioning mechanism can be integrally formed with one or more support members using an additive manufacturing process, and the positioning mechanism can be assembled by engaging the first member with the second member.

In some embodiments, an alignment body and one or more support members are made by an additive manufacturing process, and an orthodontic device is assembled by connecting one or more positioning mechanisms to the alignment body and to one or more support members. In some embodiments, an alignment body is made by an additive manufacturing process and includes recesses that include receiving contours structured to receive surfaces of a patient's teeth depicted in a three-dimensional model of the patient's dentition; and one or more support members are made by an additive manufacturing process and include one or more bracket receiving structures.

In some embodiments, an orthodontic device includes an additively manufactured alignment body, one or more support members, and one or more positioning mechanisms connecting the alignment body to support members such that, when the device is in a bonding position a bracket receiving structure of a support member in a position to dispose a bonding surface of a bracket for bonding to a tooth depicted in the three-dimensional model of the patient's dentition. In some embodiments, bonding surfaces of one or more orthodontic brackets retained in the orthodontic device include a base contour structured to receive a surface contour of a patient's tooth depicted in a three-dimensional model of a patient's dentition.

In some aspects, components of an orthodontic device including one or more support members, an alignment body, and one or more parts of a positioning mechanism can be constructed by an additive manufacturing process using one or more materials that, when cured or solidified, impart the orthodontic device with relatively high rigidity. For example, Biomed Clear marketed by Formlabs is an example of a resin that is thought to impart the desired rigidity to an orthodontic device when cured. In other forms, more flexible resins, ceramics, or metals can provide desired stability and be utilized in an additive manufacturing process to produce an orthodontic device. In other embodiments, an orthodontic device can be thermoformed or machined to create the desired structure having the desired geometries and material properties.

An orthodontic bracket can be made separately from an orthodontic device by any one or more useful processes such as injecting molding and additive manufacturing. Examples of injecting molding processes include metal injection molding and plastic or resin injecting molding. An orthodontic bracket can generally comprise a bracket portion and a base portion. An orthodontic bracket can comprise a bracket portion and a base portion formed together as one piece by any process such as additive manufacturing or injection molding. In some forms, an orthodontic bracket can comprise an orthodontic bracket assembly including a bracket portion and a base portion that are formed separately and then attached together. The entire contents of U.S. Provisional Application No. 63/493,929 titled “Orthodontic Bracket Assembly, Process of Manufacturing Orthodontic Bracket Assembly, and Process of Manufacturing Orthodontic Appliance,” and U.S. Provisional Application No. 63/493,930 titled “Orthodontic Bracket Assembly and Process of Manufacturing Orthodontic Bracket Assembly” are incorporated herein by reference for all purposes.

An orthodontic bracket formed in one piece or as an orthodontic bracket assembly, in either case, can include a first surface structured to face away from a surface of any tooth to which the orthodontic bracket can be attached, and a bonding surface formed on a base of the bracket. A bonding surface can be structured to contact a tooth. An archwire slot can be formed in and accessible on a first surface of a bracket. An archwire slot can have an axis configured to lie generally along a mesial-distal direction of a tooth to which a bracket is configured to be attached. In some forms, an archwire slot can be open across a first side of a bracket. In other some forms, an archwire slot can comprise a molar tube fixed to or otherwise formed on the first side of the bracket.

An orthodontic bracket can comprise one or more structures for retaining an archwire in an archwire slot. An orthodontic bracket can optionally comprise one or more ligature-retaining structures configured to receive one or more ligatures and retain an archwire. A ligature can generally be attached to one or more ligature-retaining structures to hold an archwire in an archwire slot. In various forms, a ligature can comprise a metal wire, a plastic member, or an elastomeric band that can be attached to a ligature-retaining structure. In some forms, a first surface of an orthodontic bracket can comprise at least two ligature-retaining structures, such as tie wings, where a first of the ligature-retaining structures extends in a first direction lateral to an archwire slot and a second of the ligature-retaining structures extends in a second direction lateral to the archwire slot. In some forms, the first and second directions can be, respectfully, in a generally gingival direction toward a gum line of a tooth to which an orthodontic bracket is configured to be attached, and in an occlusal direction generally toward an occlusal plane corresponding to the same tooth. In some forms, a first surface of an orthodontic bracket can include a pair of spaced apart occlusal tiewings extending transversely in generally occlusal directions from an archwire slot and a pair of spaced apart gingival tiewings extending transversely in generally gingival directions from the archwire slot.

In other forms, an orthodontic bracket can include a self-ligating mechanism configured to close over and retain an archwire in an archwire slot. In some forms, a first surface of a bracket comprises a self-ligating mechanism such as a hinged door, a sliding door, or clasp. A hinged or sliding door or a clasp can be opened to permit insertion of an archwire in an archwire slot and then closed to retain the archwire in the slot. Similarly, a hinged or sliding door or a clasp of a self-ligating mechanism can be opened to permit removal of an archwire from the slot. An orthodontic bracket can include a hook configured to retain part of an elastic tie configured to span maxillary and mandibular components of an orthodontic appliance such as braces. In some forms, a hook can be added to a bracket after fixing the bracket to a patient's tooth.

In some aspects, an orthodontic bracket can be formed such that the bonding surface includes one or more of a base contour, undercut structures, cavities, and a porous structure. A bonding material or adhesive can be applied to a bonding surface. Transbond™ XT marketed by 3M™ is example of a bonding material or adhesive. Undercut structures, cavities or porous structures can be configured to receive and retain a desired amount of bonding material or adhesive to be interposed between a surface of a tooth and the bonding surface of the bracket so as to provide strong adhesion of a base portion to a tooth surface. In some forms, an orthodontic bracket can be formed at least in part by an additive manufacturing process such that the bonding surface includes one or more of a base contour, undercut structures, cavities, and a porous structure.

A base contour of an orthodontic bracket can be structured to receive a surface contour of a patient's tooth to which base of the bracket is configured to be attached. A base contour can be calculated from a surface contour of a tooth depicted in a three-dimensional model of a patient's dentition. In some forms, a structure of a base contour can be calculated as any of a negative impression, a Boolean subtract, or a mathematical best fit approximation of a surface contour of a patient's tooth depicted in a three-dimensional model.

In some embodiments, when an orthodontic device includes a bracket retained in a cavity of a bracket receiving structure, and a bonding surface of the retained bracket can include a base contour structured to interface with an intended bonding location of a tooth. An orthodontic device can include one or more orthodontic brackets by inserting brackets into respective cavities of bracket receiving structures such that bonding surfaces of the brackets are disposed away from the cavities in an orientation suitable for bonding to tooth surfaces. A cavity of a bracket receiving structure can be structured to receive any one more of a ligature retaining structure, an archwire slot, a self-ligating mechanism, a ligature, an archwire, a periphery, or any other suitable structure of an bracket.

In some forms, a cavity of a bracket receiving structure can include one or more retention structures that can retain a bracket in the cavity. A retention structure can include any structure or material that engages any one or more portions of a bracket. In some embodiments, one or more retention structures engage one or more of a first surface or a peripheral edge of a bracket. In some embodiments, a retention structure engages a bracket through one or more of a friction fit or a pressure fit between the retention structure and one or more structures of the bracket. In some embodiments, a retention structure includes one or more ridges within the cavity that are structured to fit within an archwire slot of a bracket and detachably retain the bracket in the cavity through one or more of pressure or friction between the one or more ridges and the archwire slot.

In some embodiments, a friction or pressure fit is established between a peripheral edge of one or more tie wings of a bracket and an interior structure of cavity such that the cavity tightly engages the peripheral edge of the one or more tie wings. In some embodiments, one or both of a bracket and a bracket receiving structure can be constructed of material that permits elastic structural deformation and allows snapping engagement between one or more retention structures of a cavity with one or more structures of a bracket.

In some embodiments, one or more retention structures engage an underside edge of one or more tie wings of a bracket, such that a first surface of the bracket can be pressed into a cavity and the one or more tie wings can be advanced past respective retention structures formed in the cavity so that the retention structures engage underside edges the tie wings with the retention structures at least partially disposed in a gap between the tie wings and a base of a bracket. The bracket can be removed by pulling the bracket from the cavity and drawing the one or more tie wings past the retention structures until the bracket is removed from the cavity. In another form, an orthodontic bracket can include one or more retention structures to engage with one or more corners or sides of a bracket.

In some embodiments, an orthodontic device can detachably retain an orthodontic bracket through an adhesive provided in a cavity of a bracket receiving structure adhering the cavity to a one or more surfaces of the bracket. The adhesive material can temporarily retain the bracket in the cavity until the bonding surface of the bracket is attached to a tooth and the bracket can be removed from the cavity. In some forms, an adhesive provided on the interior of the cavity can have lower adhesiveness than a bonding material or adhesive applied to a bonding surface of a bracket for bonding a surface of a tooth. With this difference in adhesiveness, the bracket can remain attached to the tooth after bonding and be pulled from the cavity of the bracket receiving structure and remain on the tooth.

A package can include sealed packaging and an orthodontic device contained within the sealed packaging. In some embodiments, an orthodontic device contained in sealed packaging does not include one or more orthodontic brackets detachably retained in cavities of one or more bracket receiving structures. In other embodiments, an orthodontic device contained in sealed packaging includes one or more orthodontic brackets detachably retained in cavities of one or more bracket receiving structures. In some aspects, an orthodontic device contained in sealed packaging includes one or more orthodontic brackets detachably retained in one or cavities of one or more bracket receiving structures and an adhesive or bonding material pasted to bonding surfaces of the one or more brackets.

Sealed packaging can include any suitable material such as any one or more of polymers and metal. In some forms, sealed packaging includes one or more of polymeric film, metalized polymeric film, and metal foil. In some forms, sealed packaging can be formed from single layer or multilayered film disposed around an orthodontic device and heat sealed to contain the device. In other forms, sealed packaging can include film sealed with adhesive to contain an orthodontic device. In yet other forms, sealed packaging can comprise a blister pack enclosing an orthodontic device. Sealed packaging can have one or more properties. In some forms, sealed packaging can be one or more of light shielding and resistant to gas permeation. It is generally thought that packing including one or more materials that are one or both of light shielding and resistant to gas permeation can preserve adhesive or bonding material applied to bonding surfaces of brackets. In some forms, sealed packaging can be filled with an inert gas such as nitrogen, while substantially or fully omitting oxygen. In some aspects, the interior of sealed packaging and an contained orthodontic device contained in the packaging can be sterile.

In some forms, a process of manufacturing an orthodontic device can comprise importing or saving to a computing device, in any order or simultaneously, one or more of a three-dimensional model obtained from a patient's dentition, an orthodontic prescription for the patient's dentition, and a structural model for one or more orthodontic brackets including bonding surfaces. From information imported or saved, the computing device can generate a data file including structure data for an orthodontic device. The data file can generally include any one or more structures of an orthodontic device provided herein or contemplated from the present disclosure. The data file can then be imported and saved to an additive manufacturing device. The additive manufacturing device can then produce an orthodontic device by an additive manufacturing process.

In some embodiments, a process of manufacturing an orthodontic device produces an alignment body separately from one or more support members using an additive manufacturing method, and then connecting the alignment body to support members using one or more positioning mechanisms. In some embodiments, a process of manufacturing an orthodontic device includes integrally forming a first member of a positioning mechanism with the alignment body using an additive manufacturing method, and integrally forming a second member of the positioning mechanism with one or more support members by an additive manufacturing method and then engaging the first member with the second member to join the alignment body with the one or more support members. In some embodiments, assembling a positioning mechanism includes inserting a portion of a second member in an interior space formed in a first member and disposing a resilient member in the interior space between the first member and the second member such that the resilient member biases one or more support members including one or more bracket receiving structures toward a non-bonding position.

In some embodiments, a process of manufacturing an orthodontic device includes forming an alignment body using an additive manufacturing method, forming one or more support members by an additive manufacturing method, and then connecting the alignment body to the one or more support members using one or more pre-constructed positioning mechanisms. A pre-constructed positioning mechanism can be connected to a support member and an alignment body using any useful technique such as ultrasonic welding the parts together or adhering the parts together with adhesive.

A process of manufacturing an orthodontic device can also include comprise inserting one or more separately formed orthodontic brackets into bracket receiving structures of the device, either before or after joining one or support members to an alignment body through one or more positioning mechanisms. Together, the orthodontic device and the one or more orthodontic brackets can be used to place the one or more brackets in intended positions on a patient's dentition based on the three-dimensional model, the orthodontic prescription, and the structural model of the one or more brackets.

In another embodiment, one or more orthodontic brackets can be integrally formed with one or more support members in one piece using an additive manufacturing process based on a three-dimensional model of a patient's dentition. The brackets can be separated from the support members after bonding to teeth and then the support members can and an alignment body can be removed from the patient's dentition.

In some embodiments, a process of manufacturing an orthodontic device constructs the orthodontic device using an additive manufacturing process to form receiving contours of one or more recesses in an alignment body, base contours of one one of bonding surfaces of one or more orthodontic brackets, one or more positioning mechanisms, and one or more support members including one or more bracket receiving structures, such that when the orthodontic device is constructed and detachably retains the orthodontic brackets the bonding surfaces and recesses align with intended surfaces of a patient's teeth depicted in the three-dimensional model of the patient's dentition and according to an orthodontic prescription.

An additive manufacturing process can be controlled by a computing device programmed to control process parameters of an additive manufacturing apparatus to construct a three-dimensional object such as an orthodontic device.

In some forms, a process of using an orthodontic device can include providing an orthodontic device comprising one or more orthodontic brackets detachably retained by one or more respective cavities of the device, disposing surfaces of one or more of a patient's teeth in one or more recesses formed in an alignment body of the device, actuating one or more support members to a bonding position such that bonding surfaces of one or more brackets retained in cavities of bracket receiving structures are in a position for binding to surfaces of one or more teeth engaged with the alignment body. A process can optionally comprise retracting one or more support members to a non-bonding position after bonding one or more brackets to one or more teeth such that the brackets remain on the teeth and are withdrawn from cavities of the bracket receiving structures. In some aspects, the process can further comprise curing an adhesive contacting the bonding surfaces of the one or more brackets and surfaces of the teeth.

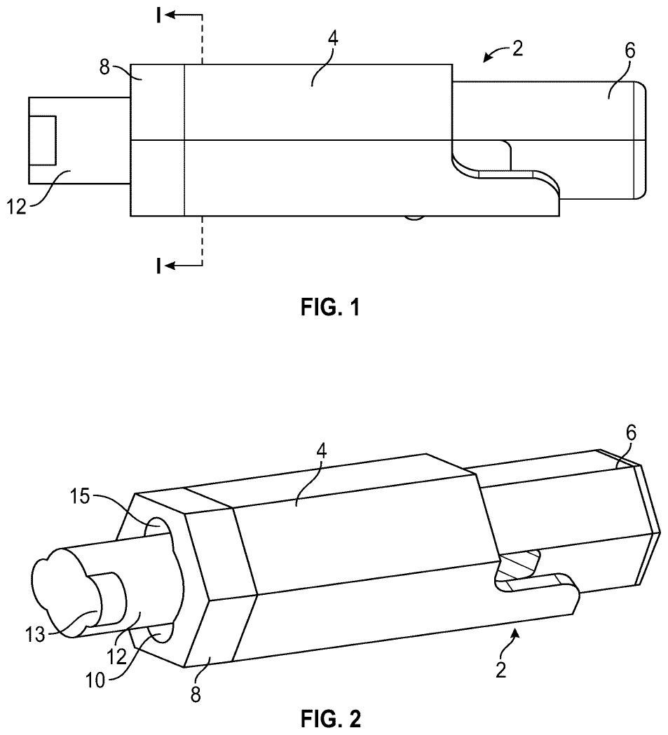

FIGS. 1-12 illustrate views of an embodiment of a positioning mechanism in various states of actuation. FIGS. 1 and 2 respectively illustrate side and perspective views of a positioning mechanism 2 locked in a position corresponding to a bonding position. The positioning mechanism includes a first member 4 slidably engaged with a second member 6. The second member 4 extends through an interior space of the first member 4 such that opposite ends of the second member protrude from the first member. A cap 8 is affixed to one end of the first member 4 to retain the second member within the first member. The cap includes an opening 10 through which a locking end 12 of the second member extends. The cap can be fed over the locking end by aligning tabs 13 on the locking end 12 with corresponding notches 15 in the opening.

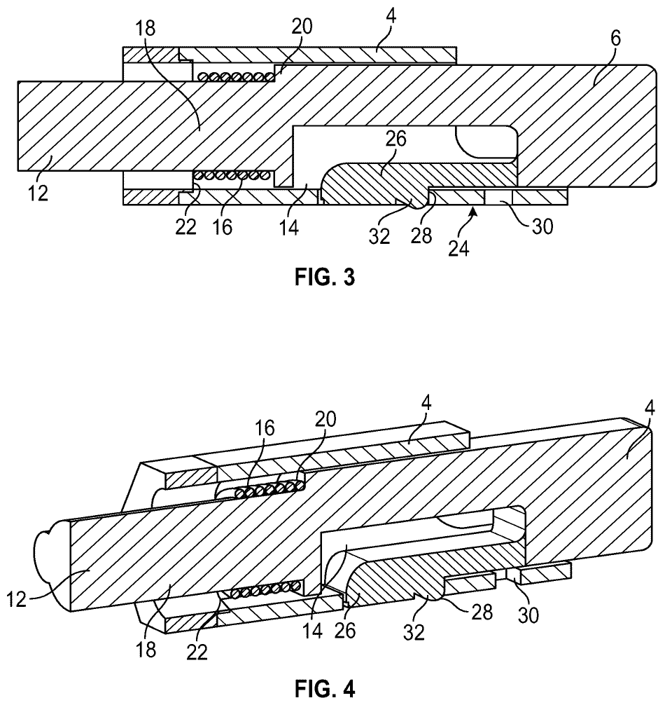

FIGS. 3 and 4 respectively illustrate side and perspective cross sections of the positioning mechanism 2 shown in FIGS. 1 and 2, taken along direction I-I in FIG. 1. The interior space 14 formed by the first member 4 receives the second member 6 therethrough. A spring 16 is disposed in the interior space between the second member 6 and the first member 4. The second member 6 includes a shaft 18 and the spring 16 is disposed over the shaft. The second member further includes an abutment 20 against upon which an end of the spring 16 rests. The cap 8 includes an abutment 22 retaining the spring 16 within the interior space 14 of the first member 4. The cap 8 can be fixed within the first member 4 using any useful connection such as a friction fit, a screw engagement, an adhesive, or an ultrasonic weld.

The positioning mechanism further includes a lock mechanism 24 including a locking tab 26, a bonding position aperture 28, and a non-bonding position aperture 30. The locking tab includes a projection 32 configured to fit within both the bonding position aperture 28 and the non-bonding precision aperture 30. In the state of actuation shown in FIGS. 1-4, the projection 32 of the locking tab 26 is engaged with the bonding position aperture 28, and the positioning mechanism is in an actuation state corresponding to a bonding position. In the bonding position, the spring 16 is compressed between the abutment 20 of the cap and the abutment 22 of the second member, and exerts a biasing force against abutments 20 and 22.

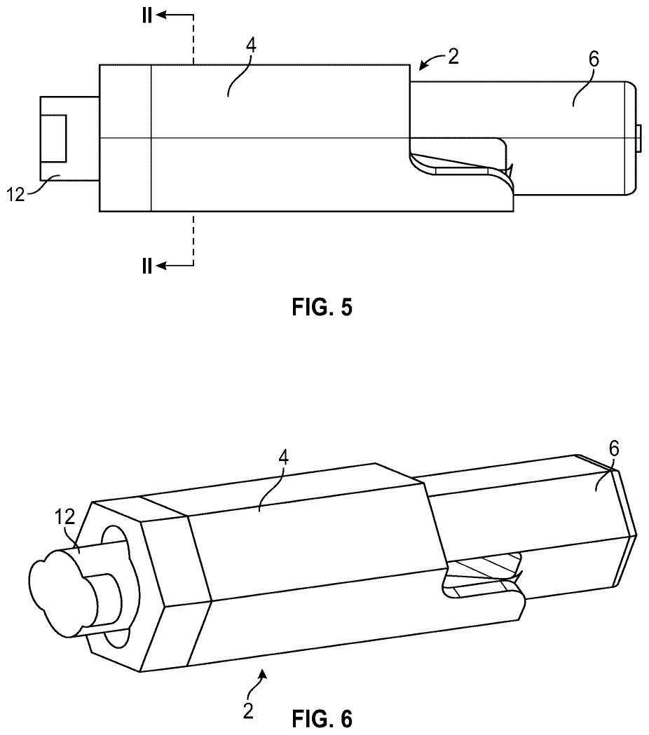

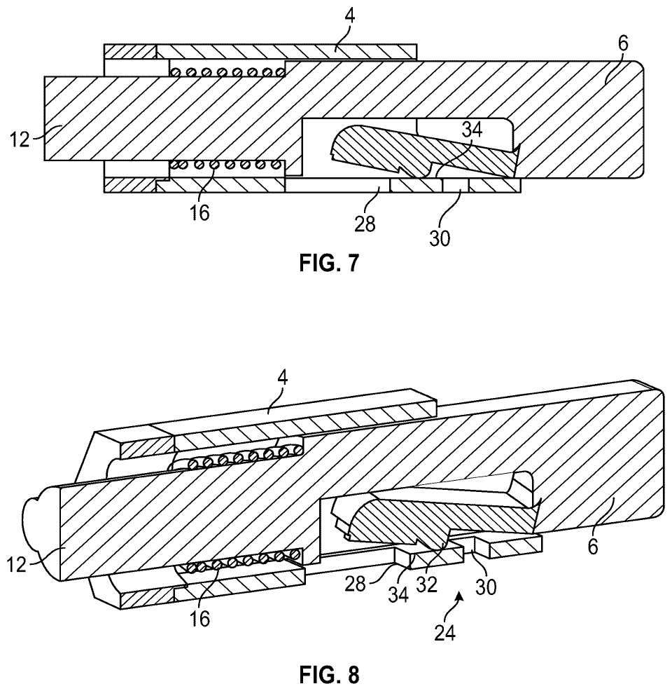

FIGS. 5 and 6 respectively illustrate side and perspective views of the positioning mechanism 2 in an actuation state corresponding to a position between a bonding position and a non-bonding position. FIGS. 7 and 8 respectively illustrate side and perspective cross sections of the positioning mechanism 2 shown in FIGS. 5 and 6, taken along direction II-II in FIG. 5. The projection 32 of the locking tab 26 rests on an inner surface 34 of the first member 4 of the positioning mechanism. The spring 16 is in a state of compression that is less compressed than the state of compression illustrated and FIGS. 3 and 4 but biases the positioning mechanism toward an actuation state corresponding to a non-bonding position.

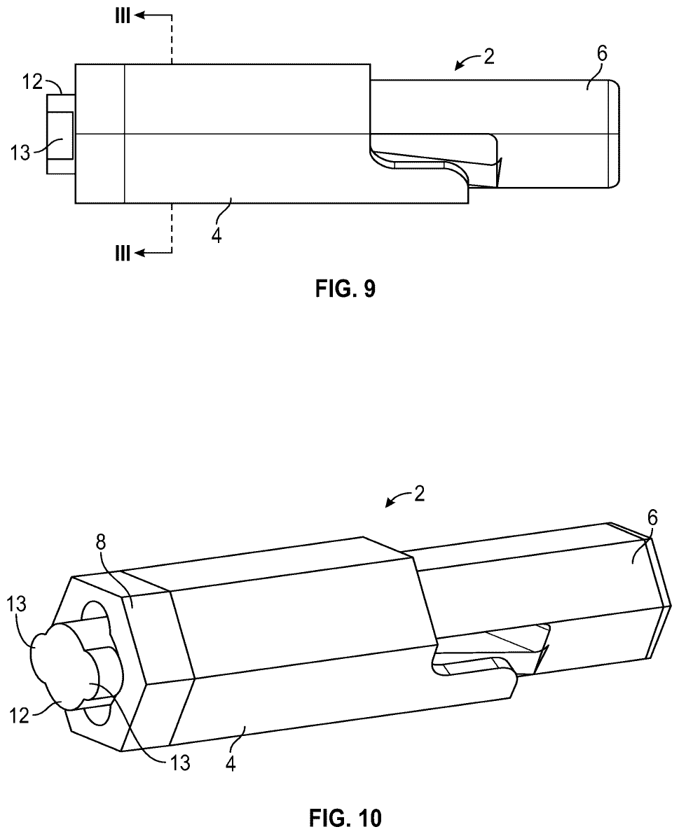

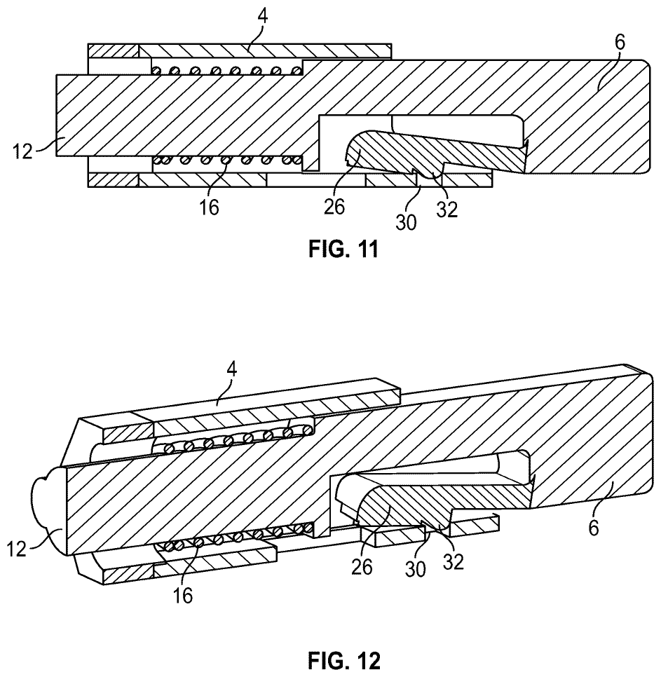

FIGS. 9 and 10 respectively illustrate side and perspective views of the positioning mechanism 2 in an actuation state actuation state corresponding to a non-bonding position. FIGS. 11 and 12 respectively illustrate side and perspective cross sections of the positioning mechanism 2 shown in FIGS. 9 and 10, taken along direction III-III in FIG. 9. The projection 32 of the locking tab 26 is engaged with the non-bonding position aperture 30. The spring 16 is in a state of compression that is less compressed than the state of compression illustrated and FIGS. 7 and 8.

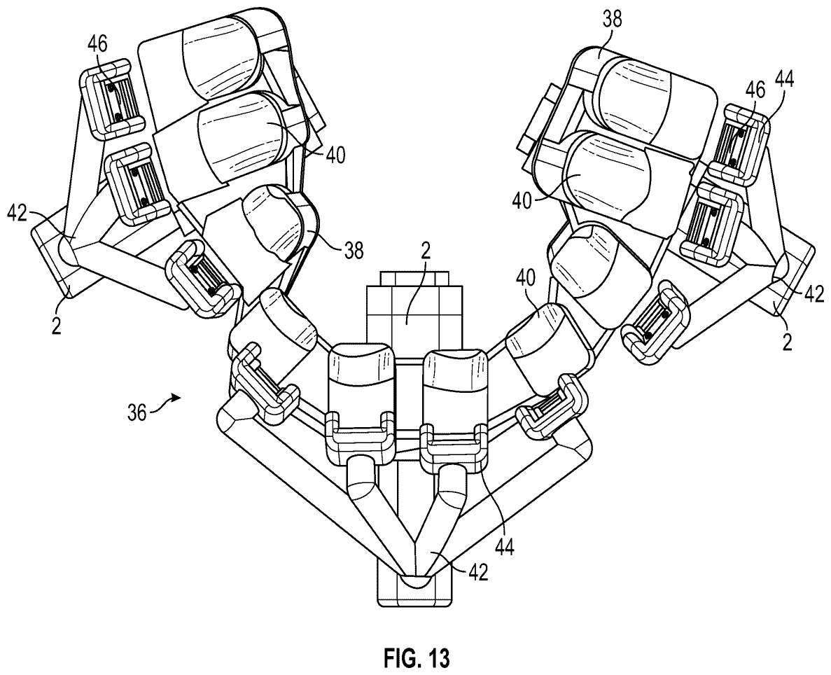

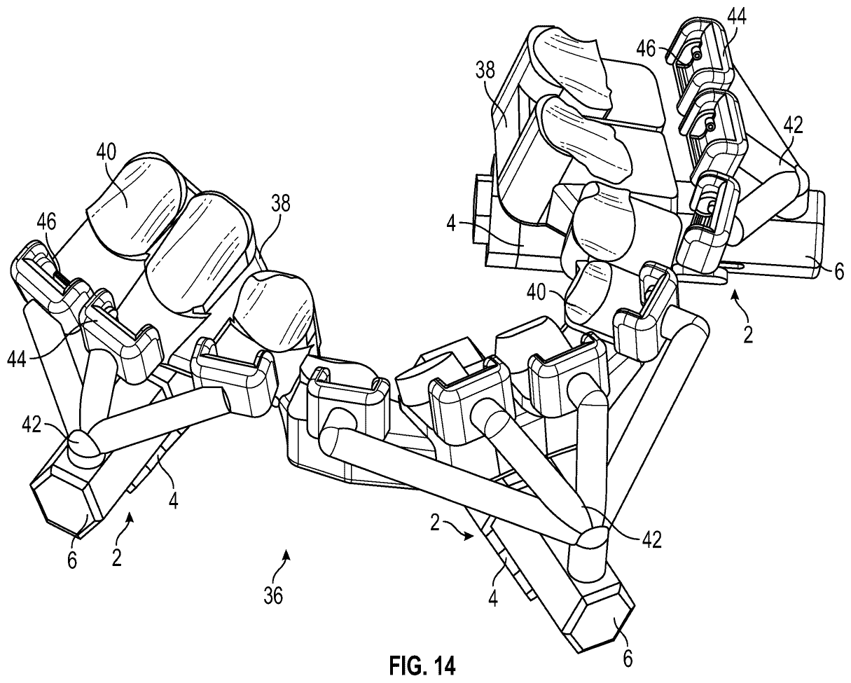

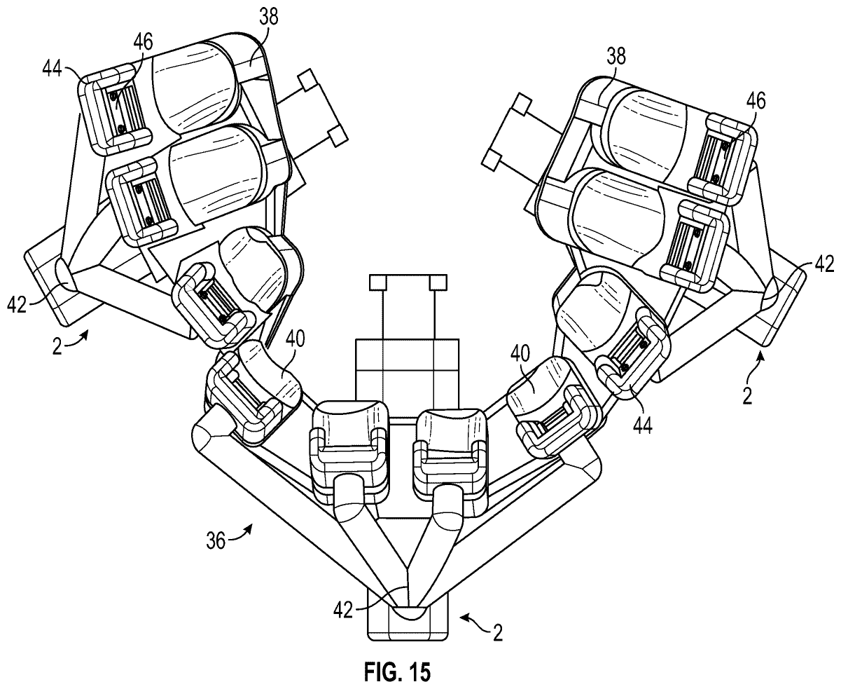

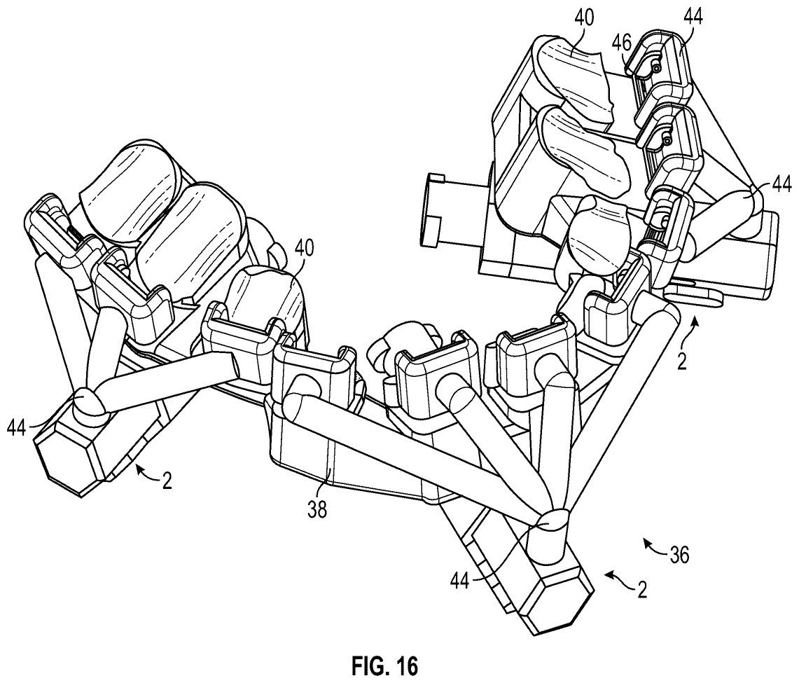

FIGS. 13-16 illustrate views of an embodiment of an orthodontic device 36. FIGS. 13 and 14 respectively illustrate plan and perspective views of the orthodontic device 36 in a non-bonding position. The orthodontic device 36 includes an alignment body 38 defining recesses 40 structured to engage portions of a plurality of a patient's teeth. The orthodontic device 36 includes three positioning mechanisms 2 connected to the alignment body 38 and support members 42. The positioning mechanisms 2 include first members 4 and second members 6. The first members 4 are connected to the alignment body 38 and the second members 6 are connected to the support members 42. The support members 42 each include plural bracket receiving structures 44. The bracket receiving structures 44 each include a cavity 46 structured to detachably retain an orthodontic bracket. The orthodontic device shown in FIGS. 13-16 does not include orthodontic brackets detachably retained in bracket receiving structures 44. FIGS. 15 and 16 respectively illustrate plan and perspective views of the orthodontic device 36 in a bonding position. The separate positioning mechanisms 2 are capable of being independently actuated to independently move the separate support members 42 relative to the alignment body 38 between a bonding position and a non-bonding position.

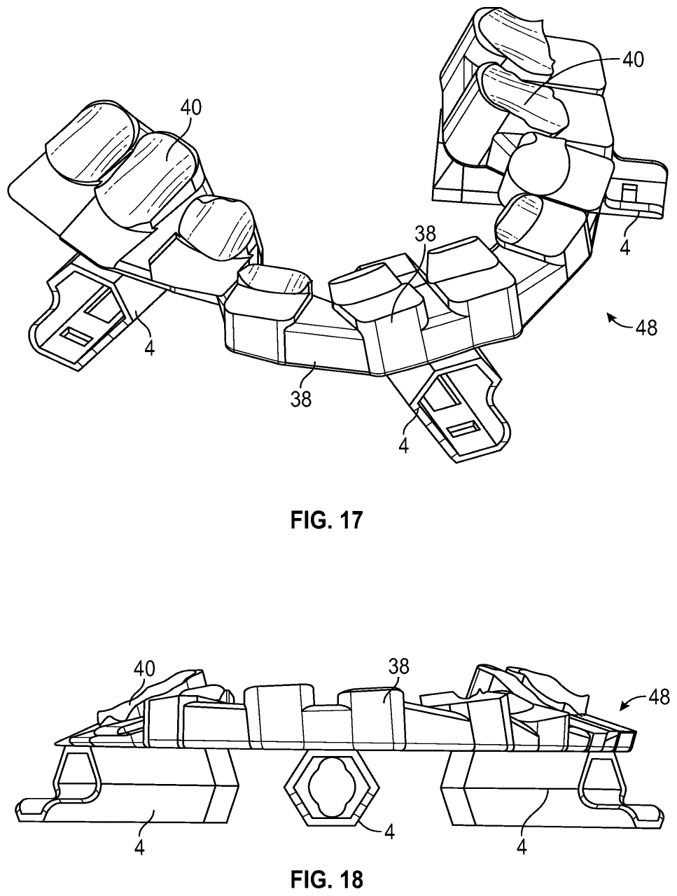

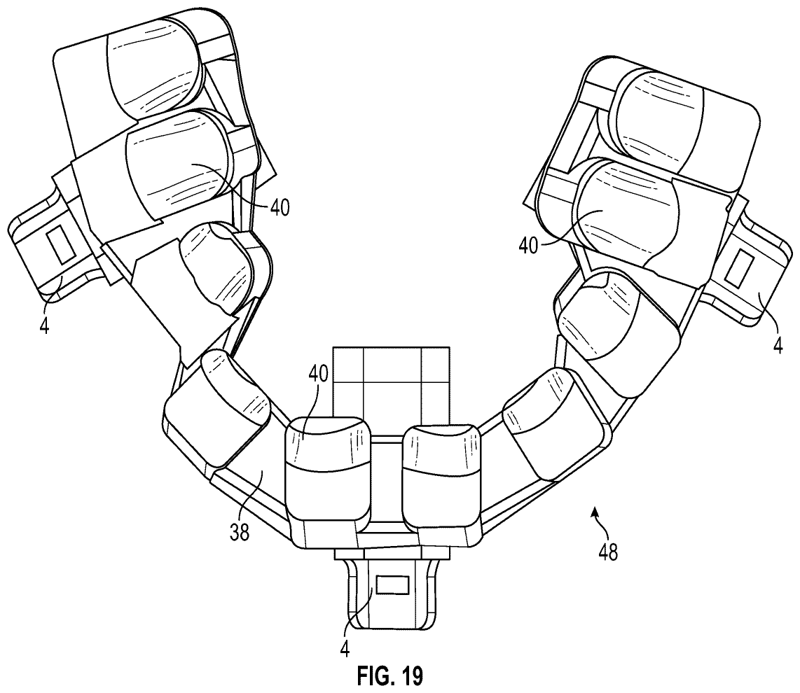

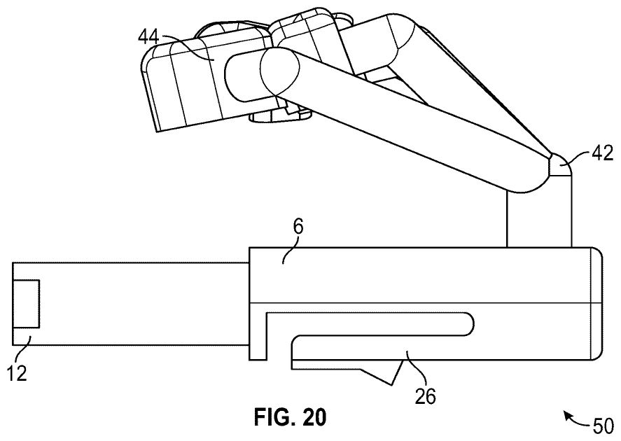

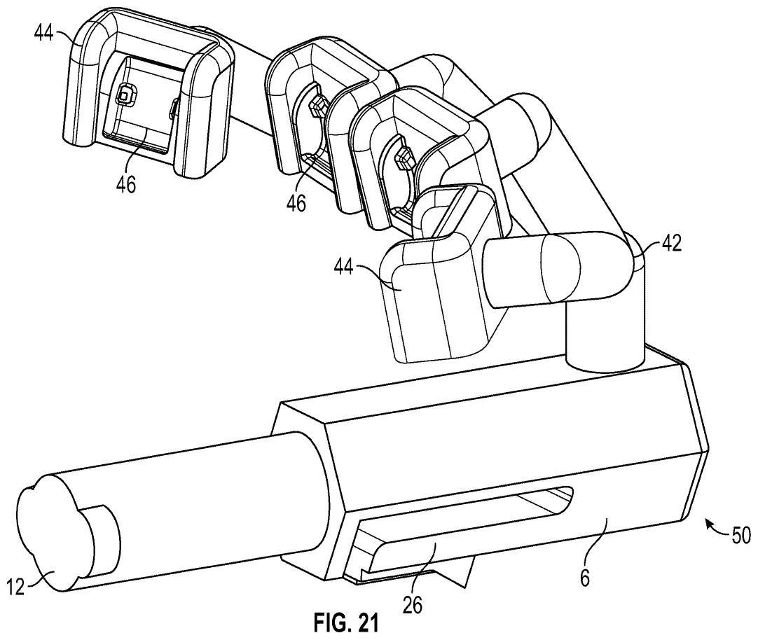

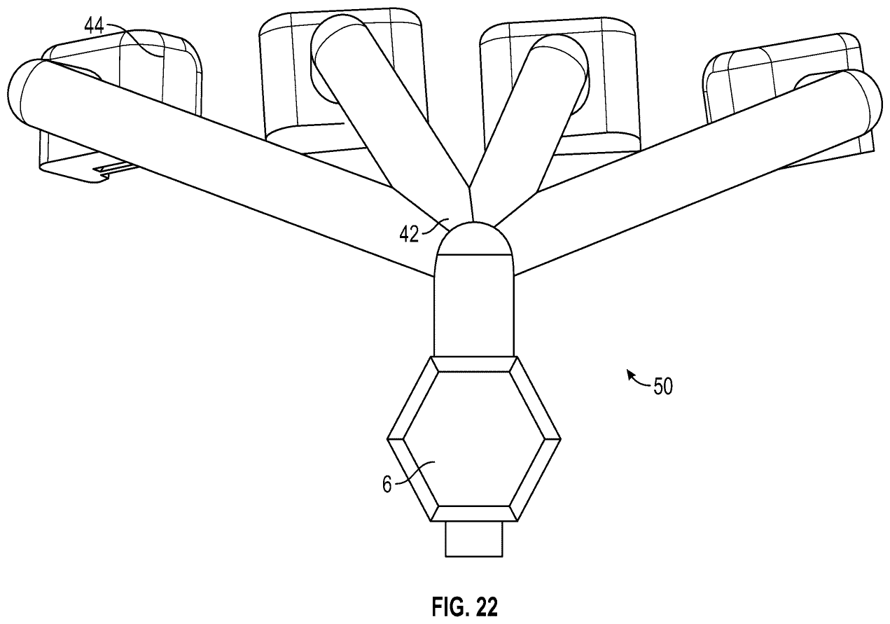

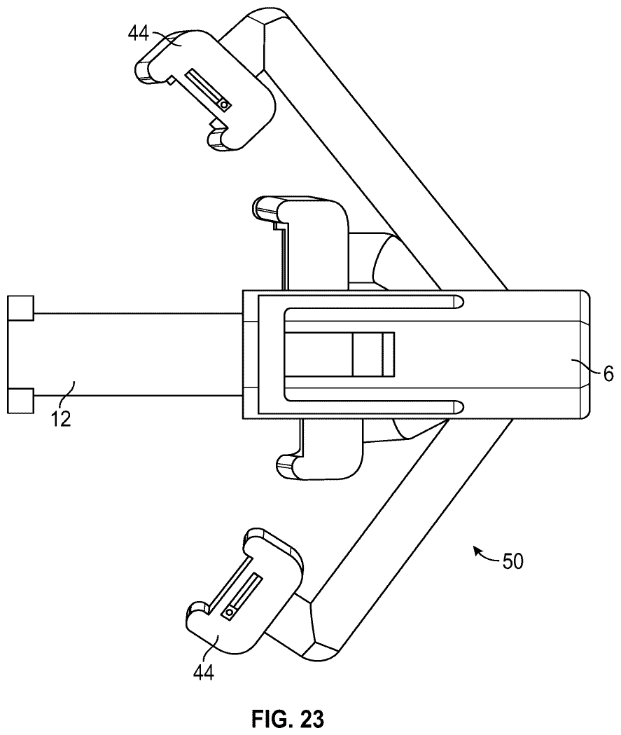

FIGS. 17-19 respectively illustrate perspective, side, and plan views of an embodiment of a first substructure 48 of an orthodontic device. The first substructure 48 includes an alignment body 38 connected to three first members 4 that can form portions of positioning mechanisms. The first substructure 48 has been made in one piece by an additive manufacturing process. FIGS. 20 and 21 respectively illustrate side and perspective views of a second substructure 50 of an orthodontic device. The second substructure 50 includes a support member 42 connected to a second member 6 that can form a portion of a positioning mechanism. FIGS. 22 and 23 respectively illustrate front and bottom views of the second substructure 50. The support member includes four bracket receiving structures 44 including cavities 46 structured to receive orthodontic brackets. An orthodontic device can be assembled by inserting a portion of a second member 6 of the second substructure into an interior space of a first member of a first substructure to form a positioning mechanism and connect a support member to an alignment body.

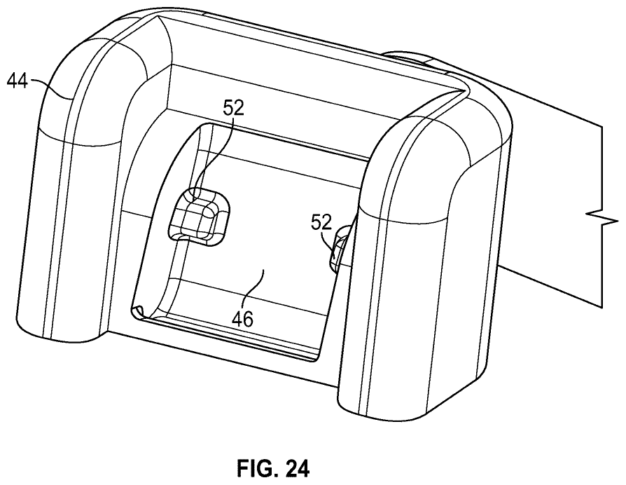

FIG. 24 illustrates a perspective view of bracket receiving structure 44 including retention structures 52 formed within a cavity 46. The retention structures 52 are sized to tightly fit within an archwire slot of a bracket and detachably retain the bracket in the cavity through friction and pressure between the retention structures and the archwire slot.

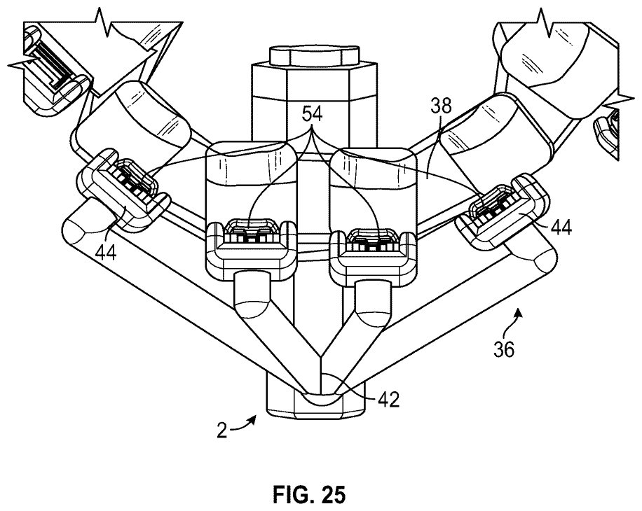

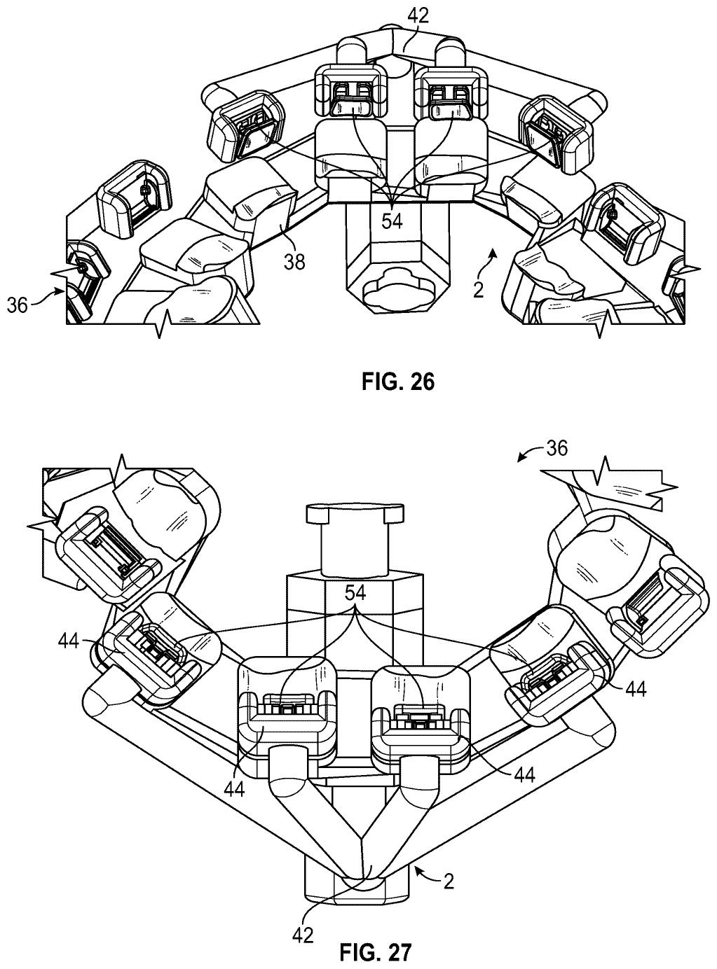

FIG. 25 illustrates a plan view of a portion of an embodiment of an orthodontic device 36 including a positioning mechanism 2 connecting an alignment body 38 to a support member 42 with the orthodontic device in a non-bonding position. Bracket receiving structures 44 include orthodontic brackets 54 detachably retained in cavities of the bracket receiving structures. FIG. 26 illustrates a perspective view of the orthodontic device in the non-bonding position of FIG. 25.

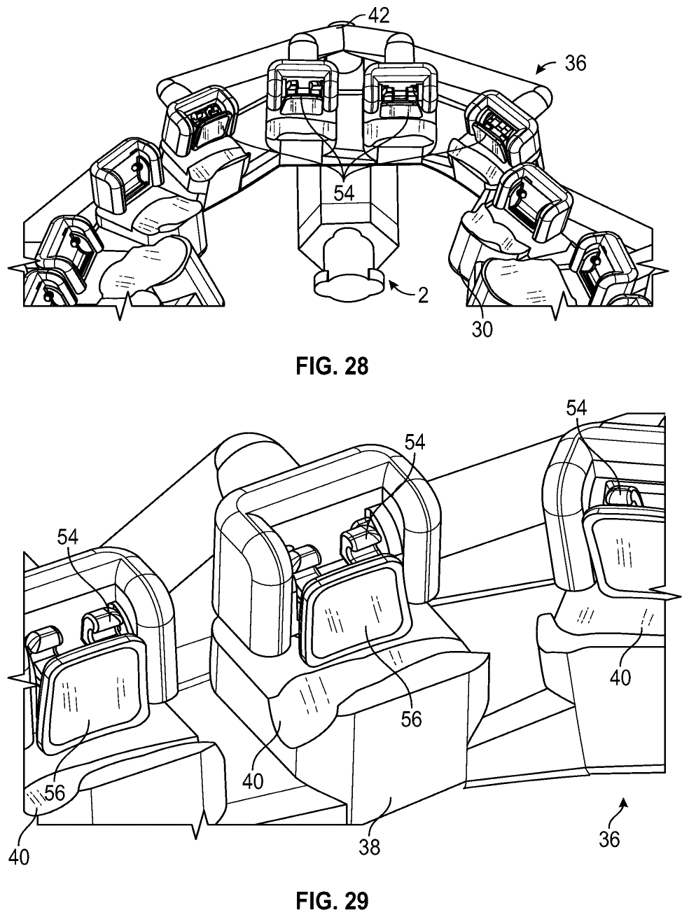

FIG. 27 illustrates a plan view of a portion of an embodiment of an orthodontic device 36 including bracket receiving structures 44 detachably retaining orthodontic brackets 54 with the orthodontic device actuated to a bonding position. FIG. 28 illustrates a perspective view of the orthodontic device in the bonding position shown in FIG. 26.

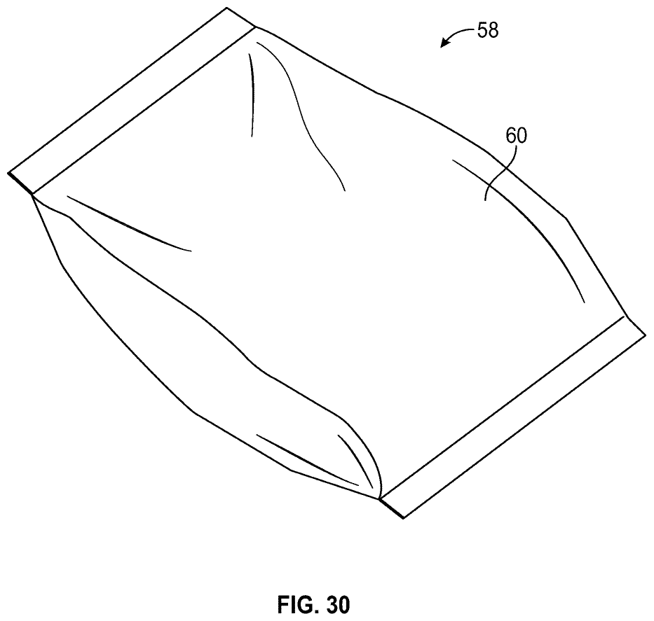

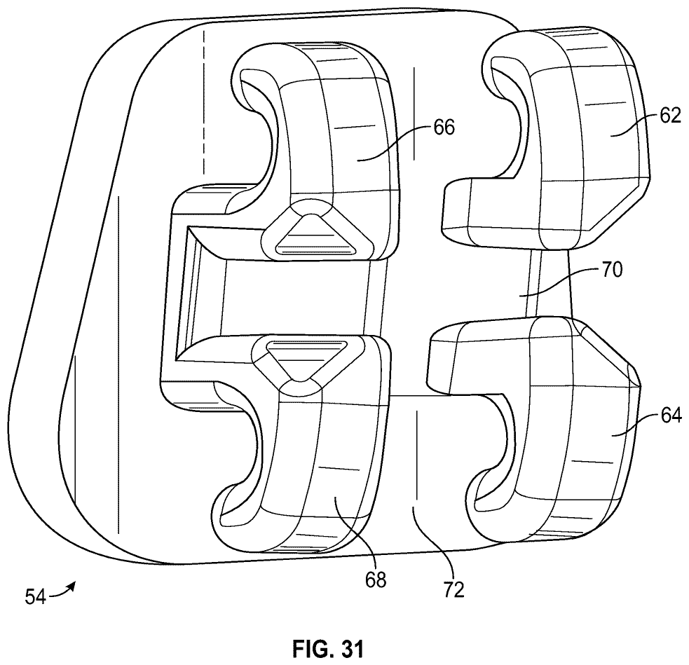

FIG. 29 illustrates an embodiment of bracket receiving structures 44 in the bonding position and retaining orthodontic brackets 54 such that bonding surfaces 56 of the brackets are adjacent to recesses 40 of the alignment body 38. FIG. 30 illustrates a package 58 comprising a barrier material 60 and containing an orthodontic device.

FIG. 31 shows a front perspective view of a first side an orthodontic bracket 54 including tie wings 62, 64, 66, 68, an archwire slot 70, and a base 72. The archwire slot can receive and be held by the retention structures 52 shown in FIG. 24.

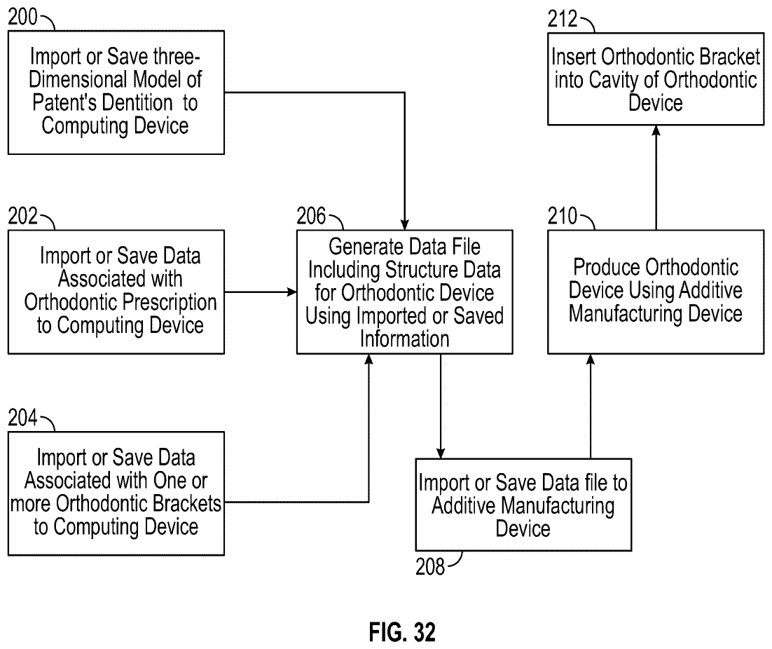

FIG. 32 shows an embodiment of a process of manufacturing an orthodontic device via additive manufacturing. The process comprises importing or saving to a computing device a three-dimensional model obtained from a patient's dentition 200, importing or saving data associated with an orthodontic prescription to the computing device 202, importing or saving data associated with a structure of one or more orthodontic brackets including bonding surfaces to the computing device 204. The components 200, 202, and 202 of the process can be performed in any order or simultaneously. The process further includes generating by the computing device a data file including structure data for an orthodontic device 206 through use of the three-dimensional model, the data associated with the orthodontic prescription, and the data associated with the structure of the one or more orthodontic brackets. The process further comprises importing or saving the data file to an additive manufacturing device 208 and using the additive manufacturing device to produce the orthodontic device 210 by additive manufacturing. In some forms, a process of manufacturing an orthodontic device can further include inserting 212 one or more orthodontic brackets into respective one or more cavities of the orthodontic device.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. Any description of certain embodiments as “preferred” embodiments, and other recitation of embodiments, features, or ranges as being preferred, or suggestion that such are preferred, is not deemed to be limiting. The invention is deemed to encompass embodiments that are presently deemed to be less preferred and that may be described herein as such. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

What is claimed is:

1. An orthodontic device comprising:
an alignment body defining recesses structured to engage portions of a plurality of a patient's teeth;
a support member comprising a bracket receiving structure, the bracket receiving structure comprising a cavity structured to detachably retain an orthodontic bracket including a bonding surface for bonding to a tooth of the patient's teeth engaged with the alignment body; and
a positioning mechanism connected to the alignment body and the support member, the positioning mechanism being structured to allow movement of the bracket receiving structure to a bonding position to permit the bonding of the bonding surface to the tooth engaged with the alignment body, and the positioning mechanism being structured to allow movement of the bracket receiving structure to a non-bonding position away from the tooth.

2. The orthodontic device according to claim 1, wherein the positioning mechanism comprises a lock mechanism structured to lock the positioning mechanism with the bracket receiving structure in the bonding position and lock the positioning mechanism with the bracket receiving structure in the non-bonding position.

3. The orthodontic device according to claim 1, wherein the positioning mechanism further comprises a resilient member biasing the bracket receiving structure toward the non-bonding position.

4. The orthodontic device according to claim 3, wherein the positioning mechanism comprises a first member connected to the alignment body and a second member connected to the support member, the first member includes an interior space receiving a portion of the second member with the resilient member between the first member and the second member within the interior space.

5. The orthodontic device according to claim 1, wherein the recesses are structured to receive at least occlusal surfaces of the patient's teeth.

6. The orthodontic device according to claim 1, wherein the alignment body has been made by an additive manufacturing process and the recesses comprise receiving contours structured to receive at least occlusal surfaces of the patient's teeth depicted in a three-dimensional model of the patient's dentition.

7. The orthodontic device according to claim 6, wherein the support member has been made by the additive manufacturing process such that the bracket receiving structure, when in the bonding position, is structured to place the bonding surface of the bracket for bonding to the tooth depicted in the three-dimensional model of the patient's dentition.

8. The orthodontic device according to claim 1, further comprising the orthodontic bracket detachably retained in the cavity.

9. An orthodontic device comprising:
a tray comprising a body defining recesses structured to receive at least occlusal surfaces of a plurality of a patient's teeth;
one or more support members at least one of which comprising a bracket receiving structure, the bracket receiving structure defining a cavity structured to detachably retain an orthodontic bracket including a bonding surface structured for bonding to a tooth of the plurality of the patient's teeth engaged with the tray; and
one or more positioning mechanisms, a positioning mechanism of the one or more positioning mechanisms comprising a first member fixed to the tray and a second member fixed to a support member of the one or more support members, the first member being engaged with the second member,
wherein the second member is reversibly movable relative to the first member to move the support member toward a bonding position and to move the support member toward a non-bonding position, and
the bonding position disposes the bracket receiving structure in a location for bonding the bonding surface of the bracket to the tooth engaged with the tray.

10. The orthodontic device according to claim 9, wherein the positioning mechanism comprises a lock mechanism structured to lock the positioning mechanism with the support member in the bonding position and lock the positioning mechanism with the support member in the non-bonding position.

11. The orthodontic device according to claim 9, wherein the positioning mechanism further comprises a resilient member biasing the support member toward the non-bonding position.

12. The orthodontic device according to claim 11, wherein the first member comprises an interior space, a portion of the second member is received within the interior space, and the resilient member is disposed in the interior space between the first member and the second member.

13. The orthodontic device according to claim 9, wherein the recesses are structured to receive at least the occlusal surfaces of a full arch of the patient's teeth, and the orthodontic device further comprises a plurality of the support members and a plurality of the positioning mechanisms connected to the support members and the tray.

14. The orthodontic device according to claim 9, wherein the tray has been made by an additive manufacturing process and the recesses comprise receiving contours structured to receive at least the occlusal surfaces of the patient's teeth depicted in a three-dimensional model of the patient's dentition.

15. The orthodontic device according to claim 14, wherein the one or more support members have been made by the additive manufacturing process such that the bracket receiving structure, when in the bonding position, is structured to place the bonding surface of the bracket for bonding to the tooth depicted in the three-dimensional model of the patient's dentition.

16. The orthodontic device according to claim 9, further comprising the orthodontic bracket detachably retained in the cavity.

17. A process of manufacturing an orthodontic device, the process comprising:
importing or saving to a computing device a three-dimensional model obtained from a patient's dentition;
importing or saving data associated with an orthodontic prescription to the computing device;
importing or saving data associated with a structure of an orthodontic bracket including a bonding surface to the computing device;
generating by the computing device a data file including structure data for an orthodontic device through use of the three-dimensional model, the data associated with the orthodontic prescription, and the data associated with the structure of the orthodontic bracket, wherein the orthodontic device comprises:
an alignment body defining recesses structured to engage portions of a plurality of a patient's teeth depicted in the three-dimensional model, and
a support member comprising a bracket receiving structure, the bracket receiving structure comprising a cavity structured to detachably retain the orthodontic bracket with the bonding surface oriented for bonding to a tooth of the patient's teeth engaged with the alignment body;
importing or saving the data file to an additive manufacturing device; and
using the additive manufacturing device to produce the orthodontic device by additive manufacturing.

18. The process according to claim 17, further comprising assembling a positioning mechanism to connect the support member to the alignment body, the positioning mechanism being structured to allow movement of the bracket receiving structure to a bonding position to permit the bonding of the bonding surface to the tooth engaged with the alignment body, and the positioning mechanism being structured to allow movement of the bracket receiving structure to a non-bonding position away from the tooth.

19. The process according to claim 18,
wherein the positioning mechanism comprises a first member integrally formed with the alignment body by the additive manufacturing device, a second member integrally formed with the support member by the additive manufacturing device, and a resilient member,
wherein the assembling of the positioning mechanism comprises inserting a portion of the second member in an interior space formed in the first member and disposing the resilient member in the interior space between the first member and the second member such that the resilient member biases the bracket receiving structure toward the non-bonding position.

20. The process according to claim 17, further comprising inserting the orthodontic bracket into the cavity.
